(19) United States
(12) Patent Application Publication
(10) Pub. No.: US 2005/0027378 A1
(43) Pub. Date: Feb. 3, 2005

(54) Machine tool turret optimizing apparatus and method

(76) Inventors: Kuo Jung Huang, Tu-chen (TW); Chung Shan Cheng, Tu-chen (TW); Zejun Dai, Shenzhen (CN); Xiaobing Gao, Shenzhen (CN); Jin Song Li, Shenzhen (CN); ZhiHui Wang, Shenzhen (CN); Wei Shao, Shenzhen (CN); Shengzhong Yi, Shenzhen (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/902,915

(22) Filed: Jul. 30, 2004

(30) Foreign Application Priority Data
Jul. 30, 2003 (TW) 92120919

(51) Int. Cl. G05B 11/01; G05B 13/02; G06F 19/00

(52) U.S. Cl. 700/28; 700/27; 700/173; 700/174

(57) ABSTRACT

An apparatus and method for turret optimizing is used in a computer-aided manufacturing system for sheet-metal punching. The system includes a server (1), a database (3), and a number of client computers (7). The apparatus (2) resides in the server, and includes a punching tool layout information obtaining module (10), a manufacturing path setting module (20), a reference punching tool selecting module (30), a fixed punching tool determining module (40), a co-radius optimizing module (50), and an included angle calculating module (60). The apparatus is used for obtaining punching tool layout information, optimizing sequences of punching tools' locations on a turret, and recording turret information.

### BACKGROUND OF THE INVENTION

1. Field of the Invention

The present invention relates to machine tool turret optimizing apparatuses and methods, and particularly to a turret optimizing apparatus and method used in a computer-aided manufacturing system for sheet-metal punching.

2. Background of the Invention

With the ongoing globalization of commerce, market competition between modern international corporations is becoming more and more intense. All such manufacturing corporations have to try their best to improve their competitiveness. Improving production efficiency is a never-ending challenge. Improvements in machine tool hardware and falling commodity prices have helped increase many corporations' efficiency. Further, the use of computers to automate manufacturing has become popular, and has improved the speed and quality of sheet-metal punching. Sheet-metal punching at the present time mostly uses CAD (Computer Aided Design) to form 3-dimension models, define workpieces, and generate manufacturing paths and codes which are sent to manufacturing centers to guide the manufacturing of parts.

One problem with automated sheet-metal punching at the present time is that location sequences of punching tool stations on a turret cannot be optimized in the process from model-forming to code-generating. To overcome this problem and to shorten manufacturing times, there is a need for an apparatus and method which can optimize the location sequences of punching tool on a turret.

### SUMMARY OF THE INVENTION

Accordingly, a main objective of the present invention is to provide a turret optimizing apparatus and method which can obtain punching tool layout information, optimize sequences of punching tools' locations on a turret, and record turret information.

To accomplish the above objective, a turret optimizing apparatus (hereinafter “the apparatus”) used in a computer-aided manufacturing system for sheet-metal punching (hereinafter “the system”) is provided herein. The system includes a plurality of client computers, a database, and a server. The database stores information such as punching tool information, turret information, punching tool layout information, information on materials of workpieces, and information on drawing entities of the workpieces. The apparatus resides in the server, and includes a punching tool layout information obtaining module, a manufacturing path setting module, a reference punching tool selecting module, a fixed punching tool determining module, a co-radius optimizing module, and an included angle calculating module.

The punching tool layout information obtaining module is used for obtaining the punching tool layout information from the database. The manufacturing path setting module is used for setting a manufacturing path for each punching tool according to distributions of the drawing entities and materials of the workpieces. The reference punching tool selecting module is used for selecting a reference punching tool and selecting a tool station for the reference punching tool. The fixed punching tool determining module is used for determining whether a punching tool other than the reference punching tool has been manufactured as a fixed one according to its style. The co-radius optimizing module is used for determining whether the punching tool can be co-radius optimized if it has not been manufactured as a fixed one; that is, for determining whether the punching tool can be mounted on a same radius line of a turret on which its preceding punching tool is mounted according to the types and parameters of both said punching tools. The included angle calculating module is used for calculating angles between the punching tool and its preceding punching tool if the punching tool cannot be co-radius optimized, for mounting the punching tool in a tool station that has a smallest angle relative to the preceding punching tool, and for recording the optimized turret information.

Further, the present invention provides a turret optimizing method comprising the steps of: (a) setting a manufacturing path for each punching tool according to distributions of drawing entities and materials of workpieces; (b) selecting a reference punching tool and selecting a tool station for the reference punching tool; (c) determining whether a punching tool other than the reference punching tool has been manufactured as a fixed one according to its type; (d) determining whether the punching tool can be co-radius optimized if it has not been manufactured as a fixed one; (e) calculating angles between the punching tool and its preceding punching tool if the punching tool cannot be co-radius optimized; and (f) mounting the punching tool in a tool station which has a smallest angle relative to the preceding punching tool.

Other objects, advantages and novel features of the present invention will be drawn from the following detailed description with reference to the attached drawings, in which:

### BRIEF DESCRIPTION OF THE DRAWINGS

FIG. 1 is a schematic diagram of an application environment of a turret optimizing apparatus according to the present invention;

FIG. 2 is a schematic diagram of main function modules of the turret optimizing apparatus of FIG. 1; and

FIG. 3 is a flowchart of a preferred method for optimizing a turret by implementing the turret optimizing apparatus of FIG. 1 according to the present invention.

### DETAILED DESCRIPTION OF THE PREFERRED EMBODIMENT

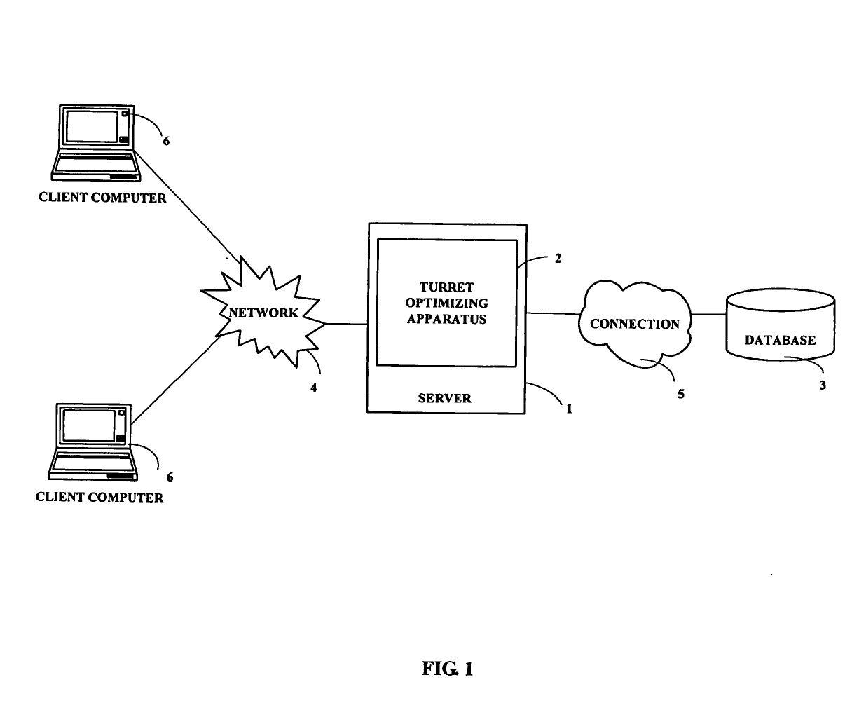

FIG. 1 is a schematic diagram of an application environment of a turret optimizing apparatus (hereinafter “the apparatus”) 2 used in a computer-aided manufacturing system for sheet-metal punching (hereinafter “the system”) according to the present invention. The system comprises a plurality of distributed client computers 6, a database 3, and a server 1. The client computers 6 are connected to the server 1 via a network 4, in order to obtain real-time turret optimizing information. The network 4 may be any suitable communication architecture required by the system, such as a local area network or a wide area network. The server 1 contains the turret optimizing apparatus 2, and is connected to the database 3 via a connection 5. The connection 5 is a database connectivity such as an Open Database Connectivity (ODBC) or a Java Database Connectivity (JDBC). The database 3 stores information such as punching tool information, turret information, punching tool layout information, and information on drawing entities and materials of workpieces. The punching tool information includes a type and parameters of each punching tool. The turret information includes a type of each turret, each punching tool's location sequence on the turret, and each tool station's size and location on the turret. The punching tool layout information includes the tool station for each punching tool on the turret, and an optimum manufacturing path of each punching tool (a machining sequence of the punching tool). The turret optimizing apparatus 2 is used for obtaining punching tool layout information, optimizing sequences of punching tools' locations on the turret, and recording turret information.

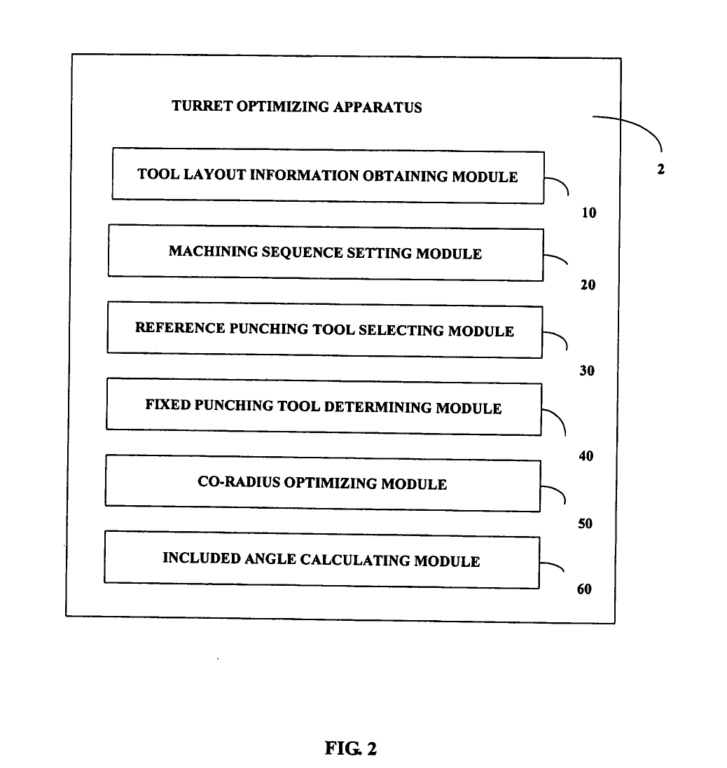

FIG. 2 is a schematic diagram of main function modules of the turret optimizing apparatus 2. The turret optimizing apparatus 2 includes a punching tool layout information obtaining module 10, a manufacturing path setting module 20, a reference punching tool selecting module 30, a fixed punching tool determining module 40, a co-radius optimizing module 50, and an included angle calculating module 60. The punching tool layout information obtaining module 10 is used for obtaining punching tool layout information. The manufacturing path setting module 20 is used for setting a manufacturing path for each punching tool according to distributions of drawing entities and materials of workpieces. The reference punching tool selecting module 30 is used for selecting a reference punching tool and selecting a tool station for the reference punching tool. The fixed punching tool determining module 40 is used for determining whether a punching tool other than the reference punching tool has been manufactured as a fixed one according to its type, and for mounting the punching tool in a corresponding fixed tool station if the punching tool has been manufactured as a fixed one. The co-radius optimizing module 50 is used for determining whether the punching tool can be co-radius optimized if it has not been manufactured as a fixed one, and for co-radius optimizing the punching tool if it can be co-radius optimized. According to the preferred embodiment, co-radius optimizing a punching tool means mounting the punching tool on a same radius line of a turret on which its preceding punching tool is mounted according to the types and parameters of both said punching tools. The included angle calculating module 60 is used for calculating angles between the punching tool and the preceding punching tool if the punching tool cannot be co-radius optimized, for mounting the punching tool in a tool station which has a smallest angle relative to the preceding punching tool, and for recording the optimized turret information.

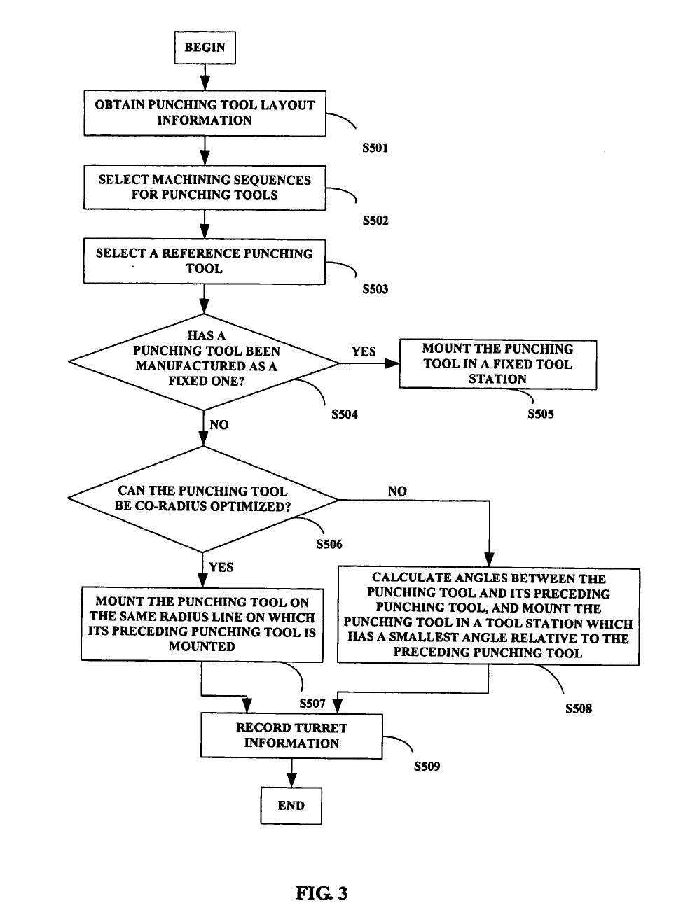

FIG. 3 is a flowchart of a preferred method for optimizing a turret by implementing the turret optimizing apparatus 2. In step S501, the punching tool layout obtaining module 10 obtains punching tool layout information from the database 3. In step S502, the manufacturing path setting module 20 sets manufacturing paths for punching tools according to distributions of drawing entities and materials of workpieces. In step S503, the reference punching tool selecting module 30 selects a reference punching tool and a tool station for the reference punching tool. In step S504, the fixed punching tool determining module 40 determines whether a punching tool other than the reference punching tool has been manufactured as a fixed one. If the punching tool has been manufactured as a fixed one, in step S505, the fixed punching tool determining module 40 mounts the punching tool in a corresponding fixed tool station. If the punching tool has not been manufactured as a fixed one, in step S506, the co-radius optimizing module 50 determines whether the punching tool can be co-radius optimized. If the punching tool can be co-radius optimized, in step S507, the co-radius optimizing module 50 mounts the punching tool on the same radius line which its preceding punching tool is mounted. If the punching tool cannot be co-radius optimized, in step S508, the included angle calculating module 60 calculates angles between the punching tool and its preceding punching tool, and mounts the punching tool in a tool station which has a smallest angle relative to the preceding punching tool. Finally, in step S509, the included angle calculating module 60 records the turret information.

Although the present invention has been specifically described on the basis of a preferred embodiment and a preferred method, the invention is not to be construed as being limited thereto. Various changes and modifications may be made to the embodiment and method without departing from the scope and spirit of the invention.

1. A turret optimizing apparatus for optimizing sequences of punching tools' locations on a turret, comprising:
a punching tool layout information obtaining module for obtaining punching tool layout information from a database;
a manufacturing path setting module for setting manufacturing paths of punching tools according to materials of workpieces and distributions of drawing entities of the workpieces;
a reference punching tool selecting module for selecting a reference punching tool and a tool station for the reference punching tool;
a fixed punching tool determining module for determining whether a punching tool other than a reference punching tool has been manufactured as a fixed one;
a co-radius optimizing module for determining whether a punching tool can be co-radius optimized, and for mounting the punching tool on a same radius line on which its preceding punching tool is mounted if the punching tool can be co-radius optimized; and
an included angle calculating module for calculating one or more angle between the punching tool and the preceding punching tool if the punching tool cannot be co-radius optimized, and for mounting the punching tool in a tool station which has a smallest angle relative to the preceding punching tool.

2. The turret optimizing apparatus according to claim 1, wherein the included angle calculating module is further used for recording optimized turret information.

3. The turret optimizing apparatus according to claim 1, wherein the turret optimizing apparatus is adapted to be used in a computer-aided system for sheet-metal punching.

4. A turret optimizing method, comprising the steps of:
obtaining punching tool layout information;
setting manufacturing paths for punching tools according to materials and distributions of drawing entities of workpieces;
selecting a reference punching tool and a tool station for the reference punching tool;
determining whether a punching tool other than the reference punching tool has been manufactured as a fixed one;
determining whether the punching tool can be co-radius optimized if the punching tool has not been manufactured as a fixed one; and
calculating one or more angles between the punching tool and its preceding punching tool if the punching tool cannot be co-radius optimized, and mounting the punching tool in a tool station which has a smallest angle relative to the preceding punching tool.

6. The turret optimizing method according to claim 5, further comprising the step of mounting the punching tool in a fixed tool station if the punching tool has been manufactured as a fixed one.

7. The turret optimizing method according to claim 5, further comprising the step of mounting the punching tool on a same radius line on which its preceding punching tool is mounted if the punching tool can be co-radius optimized.

8. The turret optimizing method according to claim 5, further comprising the step of recording turret information and storing it in a database.

9. A turret optimizing method, comprising the steps of:
obtaining punching tool layout information;
setting manufacturing paths for punching tools according to materials and distributions of drawing entities of workpieces;
selecting a reference punching tool and a tool station for the reference punching tool;
determining whether a punching tool other than the reference punching tool has been manufactured as a fixed one;
determining whether the punching tool can be co-radius optimized if the punching tool has not been manufactured as a fixed one.
